(19) United States
(12) Patent Application Publication
(10) Pub. No.: US 2022/0277035 A1
(43) Pub. Date: Sep. 1, 2022

(54) METHODS AND SYSTEMS FOR TEXT SUMMARIZATION USING GRAPH CENTRALITY

(71) Applicant: INTUIT INC., Mountain View, CA (US)

(72) Inventor: Mithun GHOSH, Bangalore (IN)

(73) Assignee: INTUIT INC., Mountain View, CA (US)

(21) Appl. No.: 17/186,843

(22) Filed: Feb. 26, 2021

(51) Int. Cl. G06F 16/34; G06F 16/901; G06N 20/00; G06F 17/16

(52) U.S. Cl. CPC G06F 16/345; G06F 16/9024; G06N 20/00; G06F 17/16

(57) ABSTRACT

A method for summarizing text is disclosed. The method can include a step of generating a connected network graph based on multiple portions of the text, wherein each portion of the text is a node of the network graph. The method can include a step of determining a similarity score of the multiple nodes of the network graph, wherein the similarity score of each node is based on its similarity with other nodes of the network graph. The method can include a step of measuring a centrality of each node of the network graph using graph centrality that is based on the similarity score and ranking the nodes based on the measured centrality. The method can include a step of generating a summary of the text by using one or more top ranked nodes.

### BACKGROUND

Text summarization is a technique to obtain a context and summarize text a portion of the text. This technique can be used to efficiently summarize emails, blogs, news articles, etc. such that the size of the document containing the text can be reduced while preserving the information and context of the text.

Text summarization can be performed via an abstractive or extractive process. Abstractive text summarization techniques generally use deep learning algorithms to predict a text summary. Such techniques can be problematic because they require massive computing resources and are still not able to generate human legible text summaries.

### BRIEF DESCRIPTION OF DRAWINGS

Other objects and advantages of the present disclosure will become apparent to those skilled in the art upon reading the following detailed description of example embodiments, in conjunction with the accompanying drawings, in which like reference numerals have been used to designate like elements, and in which:

FIG. 1 shows a flowchart of a method for summarizing text according to an example embodiment of the present disclosure;

FIG. 2 illustrates a connected network graph according to an example embodiment of the present disclosure;

FIG. 3 shows a connected network graph with similarity scores between the multiple nodes of the network graph according to an example embodiment of the present disclosure;

FIG. 4 illustrates a connected network graph formed after pruning according to an example embodiment of the present disclosure;

FIG. 5A shows a connected network graph used to determine centrality according to an embodiment of the present disclosure;

FIG. 5B shows an adjacency matrix for the network graph of FIG. 5A according to an embodiment of the present disclosure;

FIG. 6 illustrates a system diagram for summarizing text according to an embodiment of the present disclosure; and

FIG. 7 illustrates an example of a machine configured to perform computing operations according to an embodiment of the present disclosure.

### DESCRIPTION

The systems and methods disclosed herein describe generating a connected network graph based on multiple portions of a text such that each portion is a node of the network graph. A similarity score of the multiple nodes can be determined and a centrality of each node can be measured using graph centrality. The nodes can be ranked based on the measured centrality and a summary of the text can be generated by using the top ranked nodes.

The present disclosure provides systems and methods focusing on extractive text summarization by implementing a non-iterative algorithmic process that is faster and more efficient than other known text summarization techniques. The disclosed extractive text summarization consumes fewer computing resources, thereby providing improvements in computing technology. The disclosed summarization techniques allow portions of the text that capture important concepts (e.g. anchoring sentences) to be used for summarization in a manner that is not dependent on user queries.

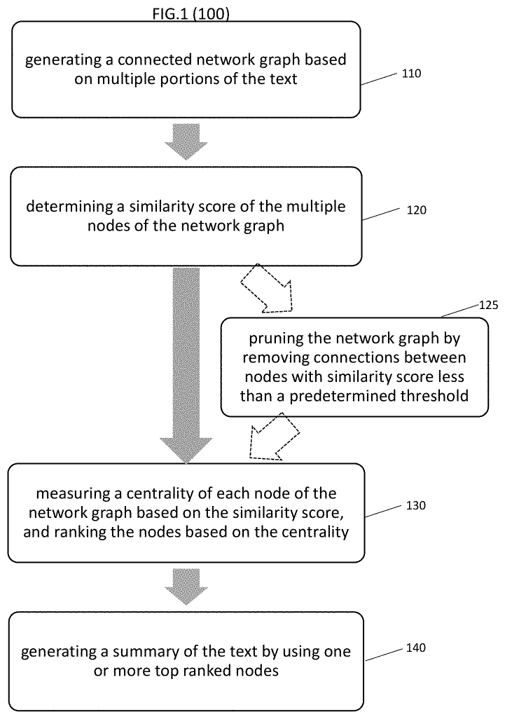

FIG. 1 shows a flowchart for a computer-implemented method 100 for summarizing text using graph centrality. In an example embodiment, the text can be a passage with multiple portions such that each portion has a meaning or conveys an idea.

The method 100 may include a step 110 of generating a connected network graph based on the multiple portions of the text. Each portion of the text can be a node of the network graph. In an example embodiment, the portion of text can be a single sentence. In an example embodiment, the portion of text can be multiple sentences.

Network graph generated by step 110 can be a mathematical structure that shows relations between nodes or identities. The network graph can include two sets: set of nodes N:{1,2, . . . n} and set of edges E{1,2,3...e}. Nodes can be objects with different attributes. Edges can be the links connecting the nodes.

In an example embodiment, each of the multiple portions of the text (e.g. sentence 1, sentence 2, sentence 3.......... sentence n) can be a node of the connected network graph. So, for a text with n portions, there can be a total of n number of nodes. For n number of nodes, there would be total (n(n-1)/2) number of edges. Edges can have many properties based on connectivity structure. For example, strength of an edge can be based on the similarity (or similarity score) between the two nodes it is connecting.

The method 100 may include a step 120 of determining a similarity score of the multiple nodes of the network graph. The similarity score of a node can be based on its similarity with other nodes of the network graph. One or more machine learning models can be used to determine the similarity.

For example, a bag of words (BOW) model can be used in step 120 to vectorize the portion of the text and a Jaccard similarity coefficient can be used to determine the similarity score. In this model, the text portion can be represented as the bag (multiset) of its words, disregarding grammar and word order but keeping multiplicity.

An implementation of the BOW model with two sentences is described as follows. The first sentence is “John likes to watch movies. Mary likes movies too.” The second sentence is “Mary also likes to watch football games”. Based on these two sentences, the following list of words is generated: “John”,“likes”,“to”,“watch”,“movies”,“Mary”,“likes”,“movies”,“too” “Mary”,“also”,“likes”,“to”,“watch”,“football”,“games”. In this list the words “likes” and “movies” occurs twice, every other word occurs once, so the BOWs can be represented as BoW1 ={“John”:1,“likes”:2,“to”:1,“watch”:1,“movies”:2,“Mary”:1,“too”:1}; BoW2 ={“Mary”:1, “also”:1,“likes”:1,“to”:1,“watch”:1,“football”:1,“games”:1}.

$$Jaccard Similarity = ( Intersection of BOW 1 and BOW 2 ) / ( Union of BOW 1 and BOW 2 ) = \frac{\begin{matrix}\{ “ John ” , “ likes ” , “ to ” , “ watch ” , “ movies ” , “ Mary ” , “ too ” \} ⋂ \\ \{ “ Mary ” , “ also ” , “ likes ” , “ to ” , “ watch ” , “ football ” , “ games ” \}\end{matrix}}{\begin{matrix}\{ “ John ” , “ likes ” , “ to ” , “ watch ” , “ movies ” , “ Mary ” , “ too ” \} ⋃ \\ \{ “ Mary ” , “ also ” , “ likes ” , “ to ” , “ watch ” , “ football ” , “ games ” \}\end{matrix}}$$

$$\frac{\{ likes , to , watch , Mary \}}{\{ \begin{matrix}“ John ” , “ likes ” , “ to ” , “ watch ” , “ movies ” , \\ “ Mary ” , “ too ” , “ also ” , “ football ” , “ games ”\end{matrix} \}}$$

$$Therefore , Jaccard Similarity = 4 / 10 = 0.4 .$$

In an example embodiment, a modified BOW model (e.g. WordNet) can also be used in step 120. Wordnet based similarity can be determined between pairs of sentences. Words linked together by semantic relationships (e.g. synonyms) can be used for classification. In some instances, this may allow to achieve an improved similarity score between sentences.

In the previously described BOW based calculation of step 120, synonymous words such as ‘too’ and ‘also’ can be considered the same. In this WordNet example, the intersection BOW1 and BOW2 can be {“likes”, “to”, “watch”, “Mary”} and the union of BOW1 and BOW2 can be {“John”, “likes”, “to”, “watch”, “movies”, “Mary”, “too”, “football”, “games”}. Therefore, the Jaccard Similarity =4/9 =0.44.

In an example embodiment, Bidirectional Encoder Representations from Transformers (BERT) model can be used in step 120. Portions of the text can be vectorized using the BERT model to represent each portion of the text with a fix length vectors (or numerical representation) to generate contextual meaning of each sentence. BERT model is described in detail at https://ai.googleblog.com/2018/11/open-sourcing- bert-state-of-art-pre.html (Feb. 10, 2021), which is incorporated by reference.

The similarity score can be determined using Pearson correlation coefficient and cosine similarity. For example, without loss of generality, two portions of a text (e.g. sentences) can be x ={ 3, 2, 0, 5 } and y ={ 1, 0, 0, 0 }. The formula for calculating the cosine similarity is: Cos(x, y) =x . y /∥x∥*∥y∥. Now, in this example, x. y =3*1+2*0+0*0+5*0=3.∥x∥=√((3)\hat{ }2+(2)\hat{ }2+(0)\hat{ }2 +(5)\hat{ }2)=6.16.∥y∥=√((1)\hat{ }2 +(0)\hat{ }2 +(0)\hat{ }2 +(0)\hat{ }2) =1. Therefore, Cos(x, y)=3/ (6.16 * 1) =0.49. So, these two sentences have edge strength (edge label as 0.49). Theoretically cosine similarity can vary between 0 and 1. 0 means they are not similar i.e. low similarity score and 1 means they are the same.

Pearson correlation coefficient theoretically can range between -1 to 1. It is derived from the formula:

$$r = \frac{n ( \sum xy ) - ( \sum x ) ( \sum y )}{\sqrt{{[ n \sum {x}^{2} - 1 \sum x )}^{2} ] [ n \sum {y}^{2} - {( \sum y )}^{2} ]}}$$

For the previous example, r=(4*3−10*1)/(sqrt((4*38−100)*(4*1 −1)) =2/sqrt(44*3)=0.17 based on the below calculations.

| | x | y | x*y | x*x | y*y |
|---|---|---|---|---|---|
| | 3 | 1 | 3 | 9 | 1 |
| | 2 | 0 | 0 | 4 | 0 |
| | 0 | 0 | 0 | 0 | 0 |
| | 5 | 0 | 0 | 25 | 0 |
| Sum | 10 | 1 | 3 | 38 | 1 |

In an example embodiment, the method 100 may include an optional step 125 of pruning the network graph by removing connections between nodes with similarity score less than a predetermined threshold before ranking the nodes. For example, if the similarity score is on a scale of 0 to 1, the threshold to prune can be 0.5. That is, all the connections among various nodes with similarity score of less than 0.5 can be removed. In other embodiments, other thresholds may be used instead of 0.5.

The method 100 may include a step 130 of measuring a centrality of each node of the network graph based on the similarity score, and ranking the nodes based on the centrality. In an example embodiment, Katz centrality can be used in step 130. Katz centrality can compute the relative influence of a node within a network by measuring the number of the immediate neighbors (first degree nodes) and also all other nodes in the network that connect to the node under consideration through these immediate neighbors.

If A is the adjacency matrix of the network graph, elements aij of A are variables that may take a value 1 if a node i is directly connected to node j and 0 otherwise. If C_{Katz} (i) denotes Katz centrality of a node i, then: C_{Katz} (i) =β(I −⊕A^{T})⁻¹.1. The βparameter can ensure that even zero-degree nodes also get a centrality measure. The ⊕parameter can decide how much centrality the connected nodes receive. If ⊕is zero, then all nodes receive same centrality. ⊕can be set as ⊕<1/λwhere λis the highest eigenvalue of matrix A. I is an identity matrix and vector ‘1’ is multiplied with β(I−⊕A^{T})⁻¹ to get a sum of rows in the resultant matrix. This calculation can be done in vectorized fashion which speeds up computation and is helpful from engineering needs of latency.

In example embodiments, Eigenvector centrality or PageRank centrality can also be similarly used in step 130. The Eigenvector centrality does not assign any importance on nodes with zero connections. PageRank centrality can provide similar capability as Katz centrality, but its implementation can be iterative.

The method 100 may include a step 140 of generating a summary of the text by using one or more top ranked nodes. The portions (e.g. sentences) of the text associated with the top ranked nodes can be combined to generate a summary of the text. An implementation of the method 100 is described with the following example with a text of seven portions (sentences).

“After a month-long delay due to the COVID-19 outbreak, Apple announced its latest family of iPhones during a virtual online event earlier this month. The new lineup includes the iPhone 12, iPhone 12 Mini, iPhone 12 Pro and iPhone 12 Pro Max, and all feature 5G connectivity, a magnetic backing branded as MagSafe that can attach to a number of accessories and a new ceramic display that promises to be more durable. You can read CNET's iPhone 12 and iPhone 12 Pro review here. With so many devices, it can get a little confusing about what makes these handsets different from each other. In general, the iPhone 12 and 12 Mini are the two most affordable phones in the lineup and have dual rear cameras. The two Pro models are the highest- end and priciest iPhones. In addition to a third telephoto camera, they also have a LiDar scanner for modeling and object detection. (Here's how and when to preorder all four iPhone 12 models at different prices.)”

Following are the BERT embeddings determined based by the process previously described in step 120:
array([[-0.05798108, 0.5119435 , 0.29716724, ..., 0.3029812 , -0.16055565, 0.28017128],
[ 0.274028 , 0.6084283 , 1.1202995 , ..., 0.6531329 , -0.28873515, -0.43358505], [ 0.8344676 , 0.00786785, 0.28357005, ..., 0.03581094, -0.12704405, 0.15644258],
[ 0.1673126 , -0.11526762, 0.38750783, ..., -0.39726564, -0.14219129, -1.2929215 ], [-0.3753484 , 0.0871636 , 1.1846875 , ..., 0.6992915 ,
0.20901915, -0.72958684],
[ 0.6159851 , 0.76033145, 0.345692 , ..., 0.12330166, 0.32752758, -0.08700331]], dtype=float32) Matrix Shape =(7,768). That is, 768-dimensional vector for each sentence.

The similarity score matrix that indicates similarity between any two pair of sentences using cosine similarity, as previously described in step 120 can be as follows:

| | 0 | 1 | 2 | 3 | 4 | 5 | 6 |
|---|---|---|---|---|---|---|---|
| 0 | 1.000000 | 0.241421 | 0.280708 | 0.229208 | 0.204106 | 0.041334 | 0.340368 |
| 1 | 0.241421 | 1.000000 | 0.502825 | 0.575259 | 0.313021 | 0.490253 | 0.431307 |
| 2 | 0.280708 | 0.502825 | 1.000000 | 0.601217 | 0.342756 | 0.353330 | 0.508024 |
| 3 | 0.229208 | 0.575259 | 0.601217 | 1.000000 | 0.644650 | 0.291496 | 0.578794 |
| 4 | 0.204106 | 0.313021 | 0.342756 | 0.644650 | 1.000000 | 0.097698 | 0.270693 |
| 5 | 0.041334 | 0.490253 | 0.353330 | 0.291496 | 0.097698 | 1.000000 | 0.216145 |
| 6 | 0.340368 | 0.431307 | 0.508024 | 0.578794 | 0.270693 | 0.216145 | 1.000000 |

Based on the similarity score matrix, centrality of each node of the network graph can be measured using Katz centrality, as previously described in step 130:
{0: 3.894389001906781, 1: 6.638835250463081, 2: 6.771757065149703, 3: 7.464071014636395, 4: 5.3616231180727265, 5: 4.411274515453419, 6: 6.288284837546822}.

As previously described in step 140, a summary of the text generated from the top ranked nodes obtained based on the centrality of each node of the network graph can be as follows: “The new lineup includes the iPhone 12, iPhone 12 Mini, iPhone 12 Pro and iPhone 12 Pro Max, and all feature 5G connectivity, a magnetic backing branded as MagSafe that can attach to a number of accessories and a new ceramic display that promises to be more durable. You can read CNET's iPhone 12 and iPhone 12 Pro review here. With so many devices, it can get a little confusing about what makes these handsets different from each other.”

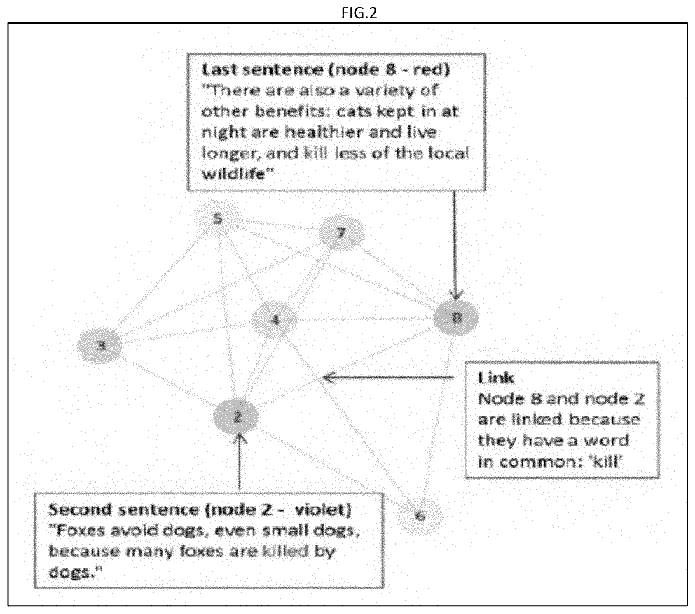

FIG. 2 shows an example of connected network graph generated by step 110. Node 2 indicative of sentence “Foxes avoid dogs, even small dogs, because many foxes are killed by dogs” is linked with node 8 indicative of sentence “There are also a variety of other benefits: cats kept in at night are healthier and live longer, and kill less of the local wildlife”. Node 2 and node 8 are linked because both use the word “kill” in a similar context.

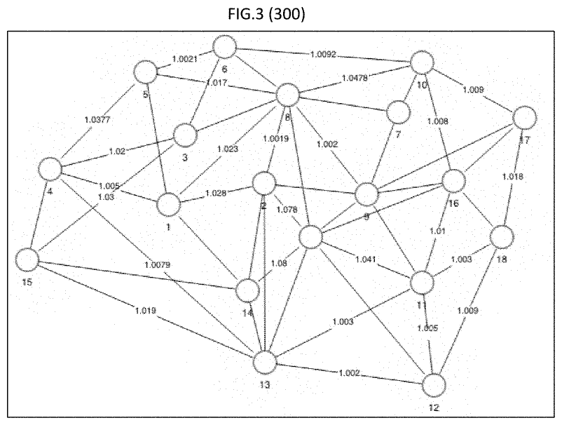

FIG. 3 shows an example connected network graph 300 with similarity scores between the multiple nodes of the network graph, as previously described in step 120. In this example, the similarity scores range from 1.001 (lowest potential similarity score) to 1.100 (highest potential similarity score).

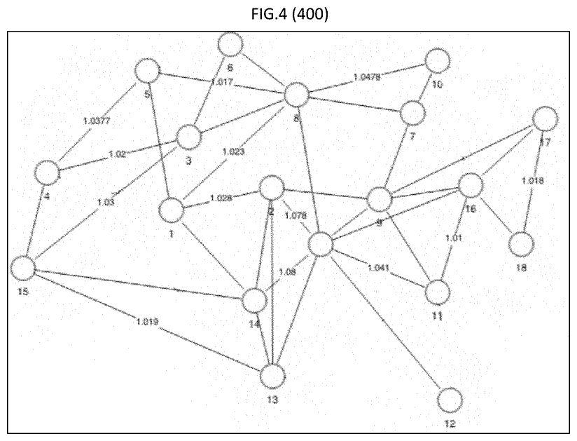

FIG. 4 shows an example connected network graph 400 that is formed after pruning graph 300 to remove connections between nodes with similarity score less than a predetermined threshold, as previously described in step 125. With a threshold of 1.099, node connections between the following nodes have been removed: nodes 12 and 13, nodes 11 and 13, nodes 12 and 11, nodes 9 and 8, nodes 11 and 18, nodes 12 and 18, nodes 6 and 10, nodes 4 and 13, nodes 5 and 6, nodes 16 and 10 and nodes 8 and 2.

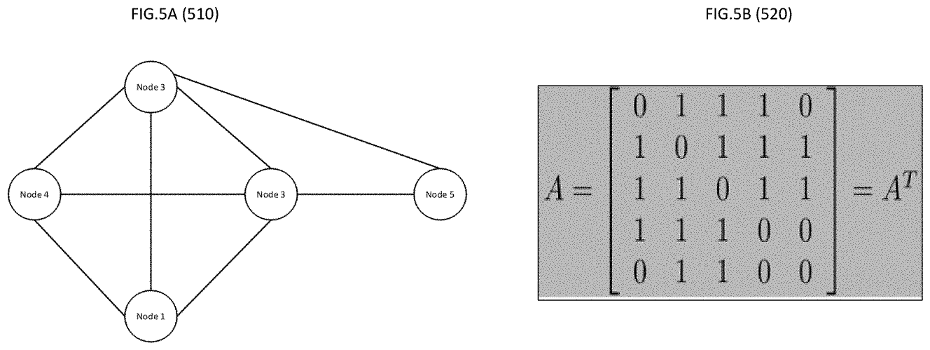

FIG. 5A shows an example connected network graph 510 with nodes 1 to 5, each node representing a portion of the text. FIG. 5B shows an adjacency matrix 520 for the network graph 510. i^{th} row and j^{th} column signify whether node i and j are related. For an undirected graph (e.g. 510), the adjacency matrix 520 is symmetric, i.e., A=transpose(A). As nodes 1 and 5 are not connected in the network graph 510, the 1^{st} column and 5^{th} row of the matrix 520 is zero. As nodes 3 and 5 are connected in the network graph 510, the 3^{rd} column and 5th row of the matrix 520 is one.

The centrality of each node in the graph 510 can be determined using Katz centrality, as previously described in step 130. Eigen values of matrix A or A^{T} can be computed as (−1.68, −1.0, −1.0, 0.35, 3.32). The highest eigen value λ=3.32 is selected and then a can be set as a <1/λ. Therefore, ⊕<1/3.32 or ⊕<0.301. For the purposes of this example, ⊕is selected as 0.25. A person of ordinary skill in the art would appreciate that ⊕is a hyperparameter that can have a value based on the importance to be given to parts of the connected graph.

βparameter be set to ensure that even zero-degree nodes also get a centrality measure. For the purposes of this example, βis selected as 0.2. Therefore, C_{Katz} (i) =β(I - ⊕A^{T})⁻¹.1 =(1.14, 1.31,1.31,1.14,0.85)^{T}. In this Katz centrality vector, first element 1.14 corresponds to first node katz centrality, second element 1.31 corresponds to second node katz centrality, third element 1.31 corresponds to third node katz centrality, fourth element 1.14 corresponds to fourth node katz centrality and fifth element 0.85 corresponds to fifth node katz centrality. As the second and third node katz centrality have the highest value, second and third nodes are considered to be the most important.

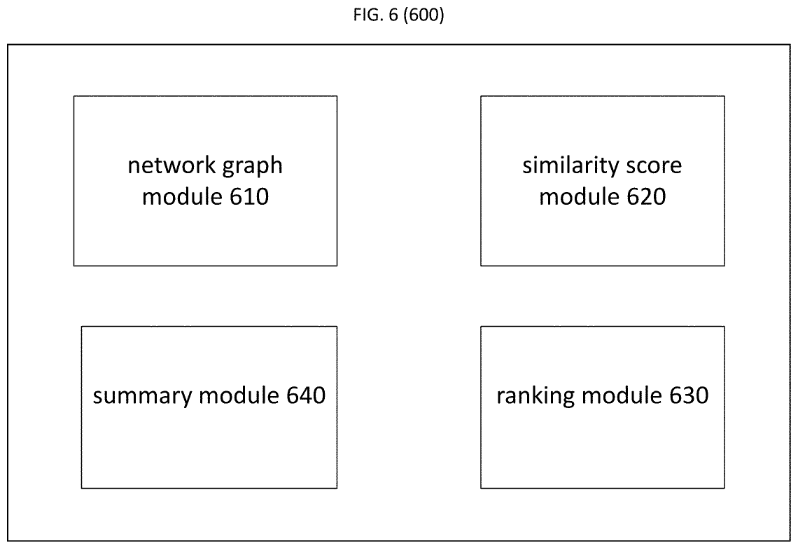

FIG. 6 shows a diagram of a system 600 for summarizing text using graph centrality. The system 600 can include a network graph module 610 configured to generate a connected network graph based on multiple portions of the text, wherein each portion of the text is a node of the network graph. Aspects of the network graph module 610 relate to the previously described step 110 of the method 100.

The system 600 can include a similarity score module 620 configured to determine a similarity score of the multiple nodes of the network graph, wherein the similarity score of each node is based on its similarity with other nodes of the network graph. Aspects of the similarity score module 620 relate to the previously described step 120 (and optionally step 125) of the method 100.

The system 600 can include a ranking module 630 configured to measure a centrality of each node of the network graph using graph centrality that is based on the similarity score and rank the nodes based on the measured centrality. Aspects of the ranking module 630 relate to the previously described step 130 of the method 100.

The system 600 can include a summary module 640 configured to generate a summary of the text by using one or more top ranked nodes. Aspects of the summary module 640 relate to the previously described step 140 of the method 100. Aspects of the system 600 are rooted in computer technology involving specific computer components, intercommunications between computing modules, data structures and logic structures which improve the operation of the computer and also improve the technologies and technical fields previously described.

Some or all of the aforementioned embodiments of the method 100 and/or system 600 can be directed to various software/products/services such as catalog services, order services, subscription services, billing services, account services, entitlement services for tax preparation software product or software service, financial management software product or software service, payroll software product or software service, accounting software product or software service, etc.

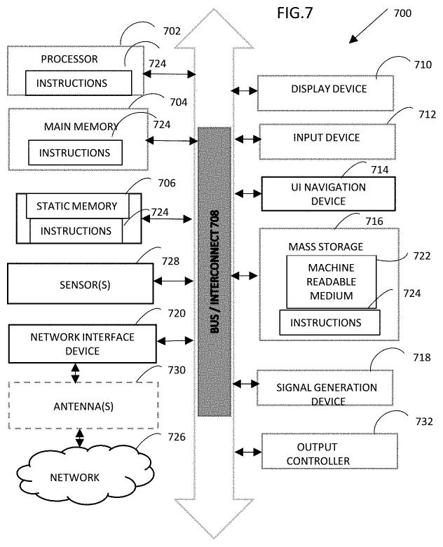

FIG. 7 is a block diagram illustrating an example computing system 700 upon which any one or more of the methodologies (e.g. method 100 and/or system 600) herein discussed may be run according to an example described herein. Computer system 700 may be embodied as a computing device, providing operations of the components featured in the various figures, including components of the method 100, system 600, or any other processing or computing platform or component described or referred to herein.

In alternative embodiments, the computing system 700 can operate as a standalone device or may be connected (e.g., networked) to other machines. In a networked deployment, the computing system 700 may operate in the capacity of either a server or a client machine in server-client network environments, or it may act as a peer machine in peer-to-peer (or distributed) network environments.

Example computer system 700 includes a processor 702 (e.g., a central processing unit (CPU), a graphics processing unit (GPU) or both), a main memory 704 and a static memory 706, which communicate with each other via an interconnect 708 (e.g., a link, a bus, etc.). The computer system 700 may further include a video display unit 710, an input device 712 (e.g. keyboard) and a user interface (UI) navigation device 714 (e.g., a mouse). In one embodiment, the video display unit 710, input device 712 and UI navigation device 714 are a touch screen display. The computer system 700 may additionally include a storage device 716 (e.g., a drive unit), a signal generation device 718 (e.g., a speaker), an output controller 732, and a network interface device 720 (which may include or operably communicate with one or more antennas 730, transceivers, or other wireless communications hardware), and one or more sensors 728.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 constituting machine-readable media.

While the machine-readable medium 722 (or computer-readable medium) is illustrated in an example embodiment to be a single medium, the term “machine- readable medium” may include a single medium or multiple medium (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, optical media, magnetic media or other non-transitory media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of several well-known transfer protocols (e.g., HTTP). Examples of communication networks include a local area network (LAN), wide area network (WAN), the Internet, mobile telephone networks, Plain Old Telephone (POTS) networks, and wireless data networks (e.g., Wi-Fi, 3G, and 4G LTE/LTE-A or WiMAX networks). The term “transmission medium” shall be taken to include any intangible medium that can store, encoding, or carrying instructions for execution by the machine, and includes digital or analog communications signals or other intangible medium to facilitate communication of such software.

Other applicable network configurations may be included within the scope of the presently described communication networks. Although examples were provided with reference to a local area wireless network configuration and a wide area Internet network connection, it will be understood that communications may also be facilitated using any number of personal area networks, LANs, and WANs, using any combination of wired or wireless transmission mediums.

The embodiments described above may be implemented in one or a combination of hardware, firmware, and software. For example, the features in the system architecture 700 of the processing system may be client-operated software or be embodied on a server running an operating system with software running thereon. While some embodiments described herein illustrate only a single machine or device, the terms “system”, “machine”, or “device” shall also be taken to include any collection of machines or devices that individually or jointly execute a set (or multiple sets) of instructions to perform any one or more of the methodologies discussed herein.

Examples, as described herein, may include, or may operate on, logic or several components, modules, features, or mechanisms. Such items are tangible entities (e.g., hardware) capable of performing specified operations and may be configured or arranged in a certain manner. In an example, circuits may be arranged (e.g., internally or with respect to external entities such as other circuits) in a specified manner as a module, component, or feature. In an example, the whole or part of one or more computer systems (e.g., a standalone, client or server computer system) or one or more hardware processors may be configured by firmware or software (e.g., instructions, an application portion, or an application) as an item that operates to perform specified operations. In an example, the software may reside on a machine readable medium. In an example, the software, when executed by underlying hardware, causes the hardware to perform the specified operations.

Accordingly, such modules, components, and features are understood to encompass a tangible entity, be that an entity that is physically constructed, specifically configured (e.g., hardwired), or temporarily (e.g., transitorily) configured (e.g., programmed) to operate in a specified manner or to perform part or all operations described herein. Considering examples in which modules, components, and features are temporarily configured, each of the items need not be instantiated at any one moment in time. For example, where the modules, components, and features comprise a general-purpose hardware processor configured using software, the general-purpose hardware processor may be configured as respective different items at different times. Software may accordingly configure a hardware processor, for example, to constitute a particular item at one instance of time and to constitute a different item at a different instance of time.

Additional examples of the presently described method, system, and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

1. A computer-implemented method for summarizing text using graph centrality, the method comprising:
generating a connected network graph based on multiple portions of the text, wherein each portion of the text is a node of the network graph;
determining a similarity score of the multiple nodes of the network graph, wherein the similarity score of each node is based on its similarity with other nodes of the network graph;
measuring a centrality of each node of the network graph using graph centrality that is based on the similarity score and ranking the nodes based on the centrality; and
generating a summary of the text by using one or more top ranked nodes.

2. The method of claim 1, wherein the portion of the text is a sentence.

3. The method of claim 1, comprising:
pruning the network graph by removing one or more connections between the nodes that have a similarity score less than a predetermined threshold before ranking the nodes.

4. The method of claim 1, wherein the determining of the similarity score is based on a machine learning model.

5. The method of claim 4, wherein the machine learning model is a bag of words model, a Bidirectional Encoder Representations from Transformers (BERT) model, or a WordNet model.

6. The method of claim 1, wherein the graph centrality is based on a Katz centrality.

7. The method of claim 6, wherein the Katz centrality is based on a highest eigenvalue of the adjacency matrix of the network graph.

8. The method of claim 6, wherein the Katz centrality is based on an identity matrix of the network graph.

9. A system for summarizing text using graph centrality, the system comprising:
a network graph module configured to generate a connected network graph based on multiple portions of the text, wherein each portion of the text is a node of the network graph;
a similarity score module configured to determine a similarity score of the multiple nodes of the network graph, wherein the similarity score of each node is based on its similarity with other nodes of the network graph;
a ranking module configured to measure a centrality of each node of the network graph using graph centrality that is based on the similarity score and rank the nodes based on the measured centrality; and
a summary module configured to generate a summary of the text by using one or more top ranked nodes.

10. The system of claim 9, wherein the portion of the text is a sentence.

11. The system of claim 9, wherein the similarity score module is further configured to prune the network graph by removing one or more connections between the nodes that have a similarity score less than a predetermined threshold before ranking the nodes.

12. The system of claim 9, wherein the similarity score module is configured to determine the similarity score based on a machine learning model.

13. The system of claim 12, wherein the machine learning model is a bag of words model, a Bidirectional Encoder Representations from Transformers (BERT) model, or a WordNet model.

14. The system of claim 9, wherein the graph centrality is based on a Katz centrality.

15. The system of claim 14, wherein the Katz centrality is based on a highest eigenvalue of the adjacency matrix of the network graph.

16. The system of claim 14, wherein the Katz centrality is based on an identity matrix of the network graph.

17. A non-transitory computer-readable medium configured to store instructions which, when executed by a processor, cause the processor to:
generate a connected network graph based on multiple portions of the text, wherein each portion of the text is a node of the network graph;
determine a similarity score of the multiple nodes of the network graph, wherein the similarity score of each node is based on its similarity with other nodes of the network graph;
measure a centrality of each node of the network graph using graph centrality that is based on the similarity score and rank the nodes based on the centrality; and
generate a summary of the text by using one or more top ranked nodes.

18. The non-transitory computer-readable medium of claim 17, wherein the portion of the text is a sentence.

19. The non-transitory computer-readable medium of claim 17, wherein the processor is further configured to prune the network graph by removing one or more connections between the nodes that have a similarity score less than a predetermined threshold before ranking the nodes.

20. The non-transitory computer-readable medium of claim 17, wherein the graph centrality is based on a Katz centrality.
